(19) United States
(12) Patent Application Publication
(10) Pub. No.: US 2010/0314890 A1
(43) Pub. Date: Dec. 16, 2010

(54) POWER CINCHING STRIKER

(76) Inventors: Todd Hemingway, Metamora, MI (US); Walter Pipp, Birmingham, MI (US); Bill Teller, Lake Orion, MI (US)

Correspondence Address: MCDONALD HOPKINS LLC, 600 Superior Avenue, East, Suite 2100, CLEVELAND, OH, 44114-2653, US

(21) Appl. No.: 12/815,198

(22) Filed: Jun. 14, 2010

Related U.S. Application Data
(60) Provisional application No. 61/268,430, filed on Jun. 12, 2009.

(51) Int. Cl. E05B 15/02

(52) U.S. Cl. 292/341.16; 292/341.15

(57) ABSTRACT

A powered striker mechanism for mounting to a support structure and for engagement with a latch mechanism to close a door. The powered striker mechanism may include a striker and a drive mechanism. The striker may include a front post that is capable of engagement with the latch. The drive mechanism may be secured to a housing, wherein the drive mechanism is engaged with a worm gear to drive a cam. A taumel gear may be driven by the cam, wherein the taumel gear includes an output post. A slide plate may be located adjacent to the housing and a slot may be located in the slide plate, wherein the post may move the striker linearly along the slot to pull the door closed. The drive mechanism may alternatively utilize a rack and pinion configuration.

### CROSS-REFERENCE TO RELATED APPLICATION

This application claims benefit from U.S. Provisional Patent Application No. 61/268,430, entitled “Power Cinching Striker,” filed on Jun. 12, 2009, which is hereby incorporated by reference in its entirety.

### FIELD OF THE INVENTION

The present invention is generally related to strikers and, more particularly, to strikers that utilize powered movement.

### BACKGROUND

Typically, a standard automotive door latch assembly includes a striker, which can take the form of a post or a U-shaped bridge member. Often, strikers may be fixedly mounted to the door frame to project into the door opening and into the path of movement of a latch member mounted on the edge of the door. In general, the latch member may be movably mounted with respect to the door and arranged so that as the door approaches its closed position, the latch member may engage the striker.

In addition, further closing movement of the door may move the latch member into a safety latch position with respect to the post. Further closing movement of the door may move the latch member into a primary latch position with respect to the post, which may positively retain the door against movement away from its closed position.

Some latches, however, require greater force to fully close the door from the primary latch position into the fully closed position. For example, sliding doors, such as those employed in vans, generally may require a greater force to move the door through the final phase of engagement and into the fully closed position. Moreover, many doors may include a resilient door seal that must be compressed before the door is fully latched. Compression of the seal may often require additional force to complete closure of the door.

Power latch and striker devices have been proposed to overcome the high force requirements to move doors into the fully closed position. Typically, power striker devices may be mounted on the door frame for powered movement between an outer or ready position with respect to the vehicle frame, where the latch may be engaged with the striker, and an inner or holding position, where the striker may hold the latch door in the fully closed position.

These devices, however, may still require a high force or momentum in order to ensure that the latch engages the striker in the primary latch position prior to movement into the fully closed position. When the door is open, the striker may be located in an outer position or ready position. When the door is closed, the latch may engage the striker and latch to the post while the striker is still in outer position.

The door may engage a limit switch or other sensor on the door when in an outer position to actuate a drive motor which, through the appropriate mechanisms, may drive the striker to an inner position. Power provided by the motor may enable the post to move the door to the fully closed position. With this arrangement, a closing force sufficient to engage the latch to the primary latch position with respect to the striker is sufficient to fully close the door. The powered movement of the striker may provide the force necessary to compress the door seal.

While powered strikers are effective in assisting with door closures, they may also present new design considerations. For example, powered strikers may require drives, gears, and other components and moving parts in order to effectuate the powered movement of the striker. These parts and components must be housed within the door frame, presenting the need for additional space. Powered strikers with low profile designs may reduce the amount of space required to house the components. Additionally, powered strikers must have sufficient power to completely move the door into fully closed position.

### SUMMARY

FA powered striker mechanism for mounting to a support structure and for engagement with a latch mechanism to close a door. The powered striker mechanism may include a striker and any appropriate type of drive mechanism. The striker may include a front post that is capable of engagement with the latch. The drive mechanism may be secured to a housing, wherein the drive mechanism is engaged with a worm gear to drive a cam. A taumel gear may be driven by the cam, wherein the taumel gear includes an output post. A slide plate may be located adjacent to the housing and a slot may be located in the slide plate, wherein the post may move the striker linearly along the slot to pull the door closed. The drive mechanism may alternatively utilize a rack and pinion configuration.

### BRIEF DESCRIPTION OF THE DRAWINGS

Objects and advantages together with the operation of the invention may be better understood by reference to the following detailed description taken in connection with the following illustrations, wherein:

FIG. 1 illustrates a side view of an embodiment of a powered striker mechanism having a post style striker.

FIG. 2 illustrates a top view of the striker mechanism of FIG. 1 having a post style striker.

FIG. 3 illustrates a side view of an embodiment of a powered striker mechanism having a U-shaped striker.

FIG. 4 illustrates a top view of the striker mechanism of FIG. 3 having a U-shaped striker.

FIG. 5 illustrates a perspective view of an embodiment of a powered striker mechanism having a taumel gear configuration.

FIG. 6 illustrates a top view of the striker mechanism of FIG. 5 having a taumel gear configuration.

FIG. 7 illustrates a side view of the striker mechanism of FIG. 5 having a taumel gear configuration.

FIG. 8 illustrates a top view of an embodiment of a powered striker mechanism having a rack and pinion gear configuration.

FIG. 9 illustrates a side view of the striker mechanism of FIG. 7 having a rack and pinion gear configuration.

FIG. 10 illustrates a perspective view of an embodiment of a powered striker mechanism for a trunk.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

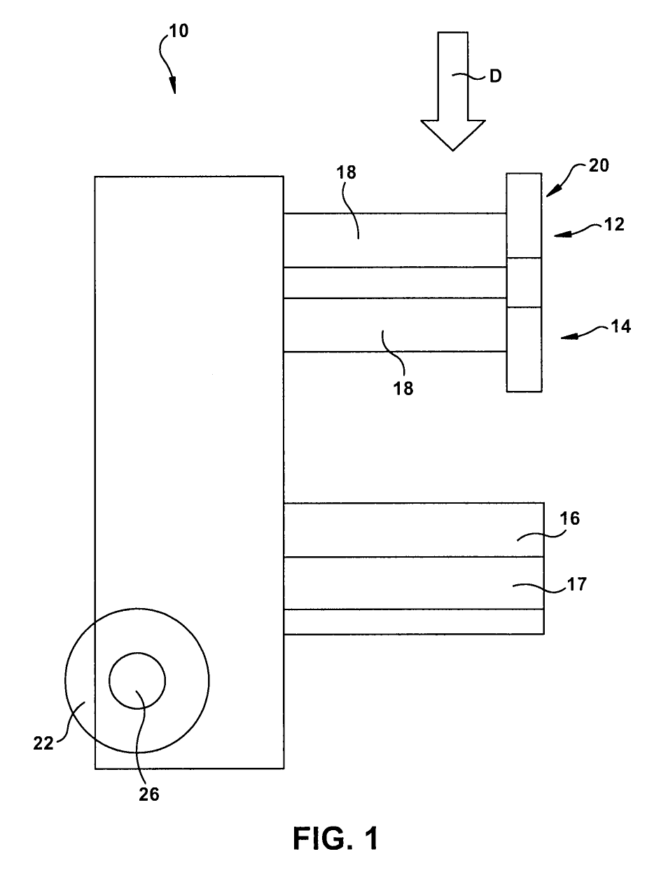

A powered striker mechanism 10 is illustrated in FIGS. 1-10. The powered striker mechanism 10 may include improved noise and vibration control characteristics and be designed to reduce or eliminate chucking, squeak and rattle concerns in a door closure, such as with a bumper 16. The powered striker mechanism 10 may be of any appropriate shape, size or configuration.

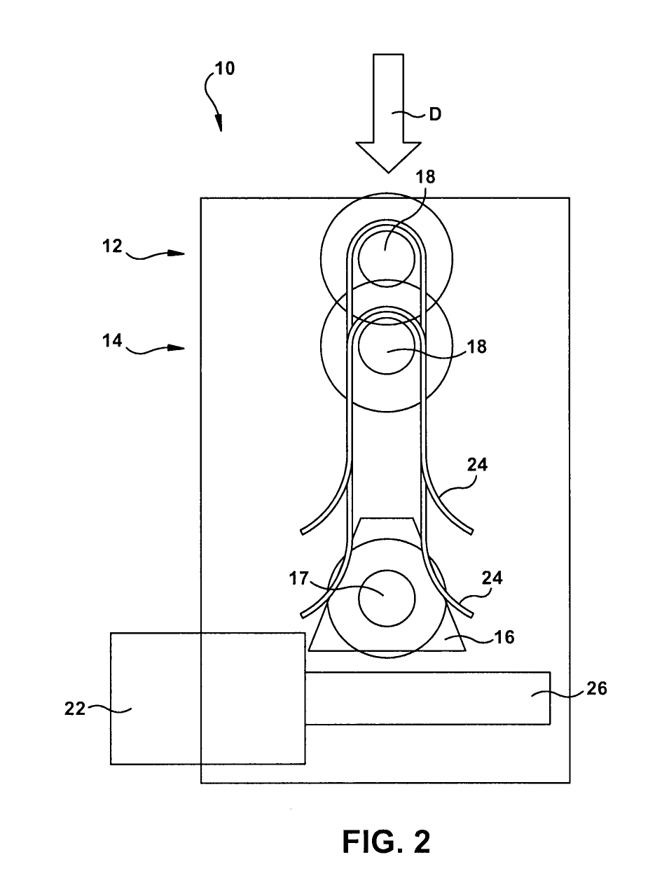

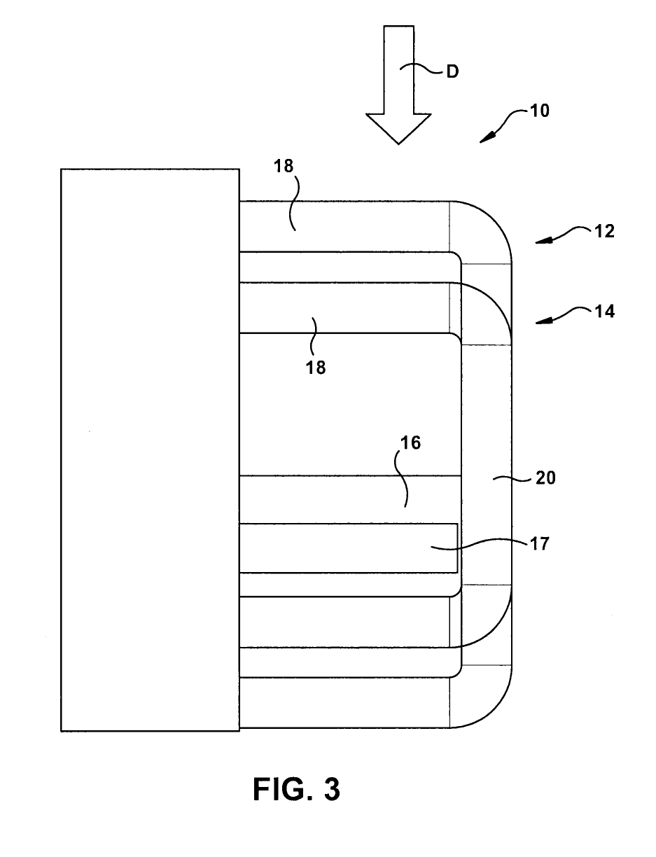

The powered striker mechanism 10 may be configured to engage a latch (not shown), such as a door latch. The powered striker mechanism 10 may include a striker 20. The striker 20 may be of any appropriate shape, size, type or configuration. For example, the striker 20 may be of a post configuration (see FIGS. 1 and 2), a U-shaped member configuration (see FIGS. 3-5), or any other appropriate configuration that may engage a latch. The latch structure may engage the striker 20. The striker 20 may also be shaped and sized to engage a fishmouth 24 of the latch.

The bumper 16 of the striker mechanism 10 may reduce chucking and rattling of the striker 10 when engaged with the latch. Typically, bumpers have been designed to dampen the engagement between the striker 10 and the latch. Often these bumpers may be attached to a back wall and include a wedged configuration. The wedged configuration may then engage the latch opening to dampen noise and vibration. U.S. patent application Ser. No. 12/316,225, which is herein incorporated by reference in its entirety, describes in further detail an embodiment of a wedge type bumper.

The bumper 16 may be located at any appropriate position on the striker 20, such as surrounding a portion of the bumper post 17 (FIGS. 1 and 2). The bumper 16 may be of any appropriate shape, size or configuration, such as a generally rectangular, square, circular, triangular, or the like. For example, the bumper 16 may be of a generally polygonal shape that may be of a larger diameter than that of the bumper post 17.

The bumper 16 may be fabricated out of any appropriate type of material. For example, the bumper 16 may be fabricated out of an elastic material, such as an elastomer or rubber. The bumper 16 may be made out of a more pliable or more rigid type of material, depending on the situation's specific needs. However, the bumper 16 may be fabricated out of any material useful in damping noise and vibration. In addition, the bumper 16 may be fabricated as a single piece or may be of separate pieces that may be secured to one another by any appropriate means, including, but not limited to, sonic welding, adhesive, mechanical fastening, or the like.

The bumper 16 may assist in reducing noise, vibration and chucking between the latch, such as the inner walls of the fishmouth 24 of the latch and the striker 20. During engagement, the latch structure may engage the striker 20, whereby an entrance or inner walls 24 of the latch may approach the bumper post 17 and bumper 16. The engagement between the bumper 16 and the inner walls 24 of the latch may allow for noise and vibration such as rattling or chucking.

The bumper 16 may be adapted to dampen the interface between the striker 20 and the latch. To that end, the bumper 16 may engage the bumper post 17 to dampen the engagement between the bumper post 17 and the inner walls of the fishmouth 24 of the latch. The bumper 16 may be connected directly to the striker 20. For example, the bumper 16 may cover a portion of the surface of the bumper post 17. Alternatively, the bumper 16 may be mounted directly to the powered striker mechanism 10, away from the striker 20.

The powered striker mechanism 10 may be mountable to a door frame and capable of moving the striker 20 between an outer position 12 and an inner position 14 in a first direction D. In the outer position 12, the striker 20 may be positioned closer to the latch and further away from the door opening. In the inner position 14, the striker 20 may be positioned closer to the door opening. The striker 20 may move linearly in a direction D between the outer position 12 and the inner position 14 (FIGS. 1-4). As an alternative, the striker 20 may move non-linearly or in any desired direction or series of directions to move between an outer position 12 and an inner position 14.

The striker 20 may include a front post 18 configured to engage the latch (FIGS. 1 and 2). The powered striker mechanism 10 may move the striker 20 to the outer position 12 when the door is open or the latch is not engaged with the front post 18. Once the door is closed and the latch engages the striker 20, a driver 22 may drive the striker 20 to the inner position 14 towards the door opening. The driver 22 may be of any appropriate type or configuration of driver that would be appropriate to operate the striker mechanism 10. For example, the driver 22 may be a motor 22. As the striker 20 moves from the outer position 12 in a direction D to the inner position 14, a portion of the front post 18 may abut the latch, thereby moving the latch and the door into the fully closed position.

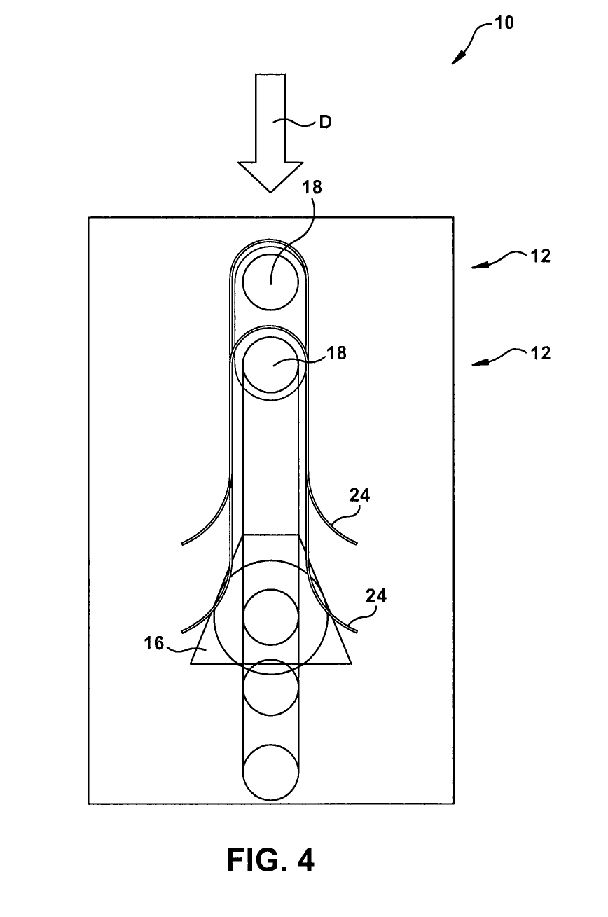

The powered striker mechanism 10 may include at least one sensor (not shown) to determine when the latch is engaged with the front post 18 and initiate movement of the striker 20. For example, the latch may include a fishmouth 24 that may engage the front post 18 (FIGS. 2 and 4). The powered striker mechanism 10 may include a sensor, such as a proximity sensor, photo sensor, magnetic sensor, or any other appropriate sensor, to determine when the fishmouth 24 is engaged with the front post 18. Once the sensor has determined that the fishmouth is engaged with the front post 18, the sensor may activate the motor 22 to drive the striker 20 from the outer position 12 to the inner position 14.

The powered striker mechanism 10 may include a plurality of gears and other components to effectuate the movement of the striker 20. The powered striker mechanism 10 may include any number, type or configuration of gears and other components to effectuate movement of the striker 20. In addition, the plurality of gears and other components may be located at any appropriate position on the powered striker mechanism 10, such as between the motor 22 and the striker 20 to effectuate the movement of the striker 20.

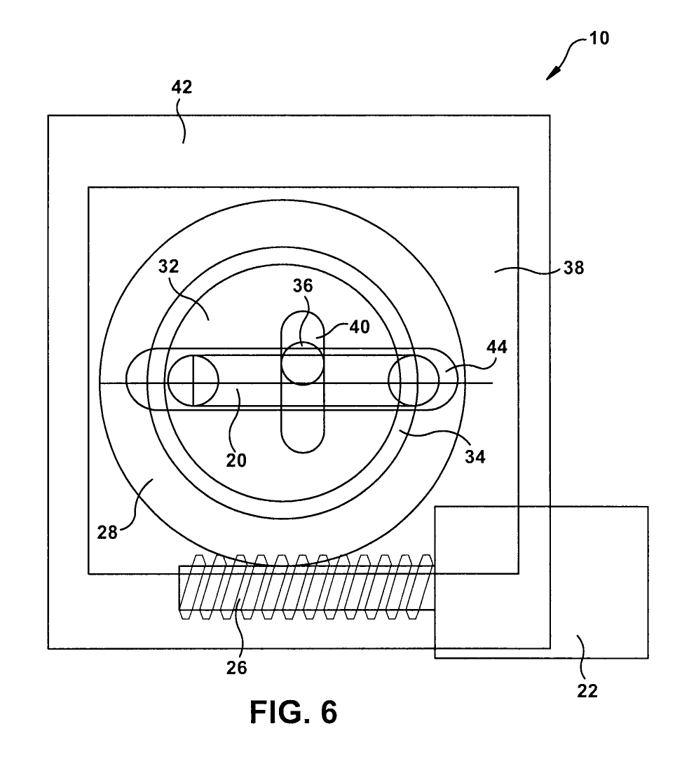

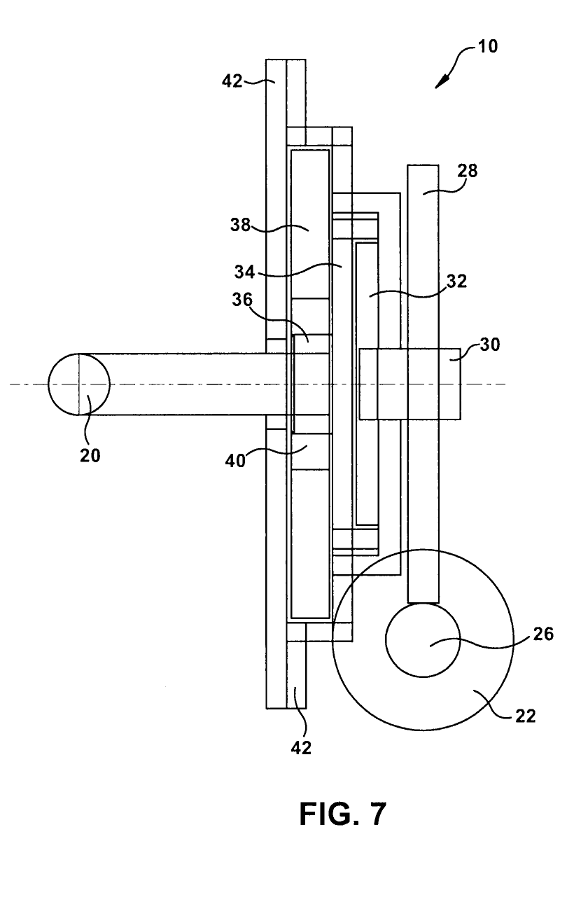

In an embodiment, the motor 22 may move the striker 20 by way of a worm gear and taumel gear 32 (FIGS. 6 and 7). Specifically, the motor 22 may drive a threaded shaft 26 configured to engage an outer gear 28. The outer gear 28 may be arranged in a worm gear configuration, such that the outer gear 28 may be perpendicular to a shaft 26 (FIGS. 6 and 7). The shaft 26 may transfer rotational movement from the motor 22 to the outer gear 28.

The powered striker mechanism 10 may further include a cam 30 (FIG. 7). The cam 30 may be connected to the outer gear 28 such that the outer gear 28 may rotationally drive the cam. The cam 30 may also connect to a taumel gear 32 to transfer rotational movement from the outer gear 28 to the taumel gear 32 (FIG. 7).

The powered striker mechanism 10 may include an output gear 34 (FIGS. 6 and 7). The taumel gear 32 may be positioned inside an output gear 34 (FIGS. 6 and 7). The engagement between the taumel gear 32 and the output gear 34 may provide a gear reduction. For example, the output gear 34 may include inner teeth configured to engage outer teeth of the taumel gear 32.

The taumel gear 32 may be configured with at least one fewer teeth than the taumel gear 32. Accordingly, the output gear 34 may move much slower than the taumel gear 32. Specifically, the taumel gear 32 may complete multiple rotations within the output gear 34 before the output gear completes a single rotation. This configuration may act to both decrease the speed of movement of the output gear 34 and increase the torque provided by the output gear 34.

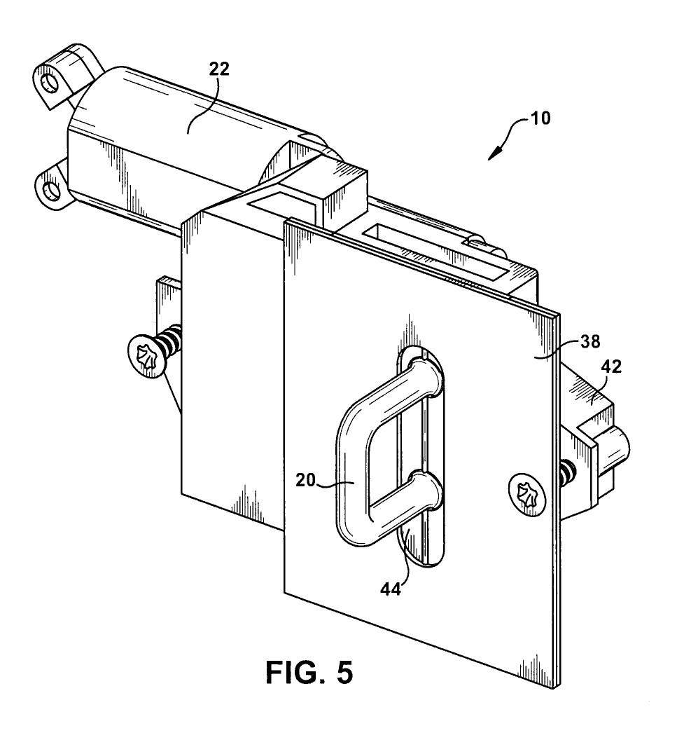

The powered striker mechanism 10 may include a slide plate 38 (FIGS. 5-7). The striker 20 may be connected to a slide plate 38 positioned in front of the output gear 34. The slide plate 38 may be slidable in a linear direction. Specifically, the slide plate 38 may be slidable in a direction parallel to the movement between the outer position 12 and the inner position 14. Thus, movement of the slide plate 38 may move the striker 20 between outer and inner positions 12, 14.

The slide plate 38 may include a slot 40 (FIGS. 5-7). The slot 40 may be arranged substantially perpendicular to the direction of movement of the slide plate 38. The output gear 34 may include an output post 36 connected thereto.

An output post 36 connected to the output gear 34 may be positioned within the slot 40 and capable of traveling therein (FIGS. 6 and 7). Rotation of the output gear 34 causes the output post 36 to move a distance in two dimensions, namely a distance within the slot 40, and a distance perpendicular to the slot. Thus, rotation of the output gear 34 causes the output post to push the slide plate perpendicular to the slot 40, moving the slide plate 38 and striker 20 between the outer position 12 and the inner position 14.

The slide plate 38 may be located in front of the output gear 34 and include a slot 40 (FIGS. 6 and 7). The output post 36 may be positioned within the slot 40 and moveable therein. The slide plate 38 may be slidable between the outer position 12 and the inner position 14. The striker 20 may be connected to the slide plate 38 to move between the outer and inner positions 12, 14.

The powered striker mechanism 10 may include a housing 42 (FIGS. 5-7 and 10). The housing 42 may be positioned about the exterior of the powered striker mechanism 10. The housing 42 may enclose the gears, motor 22, and other moving parts to protect them from damage or corrosion. The housing 42 may include an opening 44 (FIGS. 5-7). The opening 44 may allow the striker to move between the outer and inner positions 12, 14. The opening 44 may be linear and correspond to the linear travel of the striker 20.

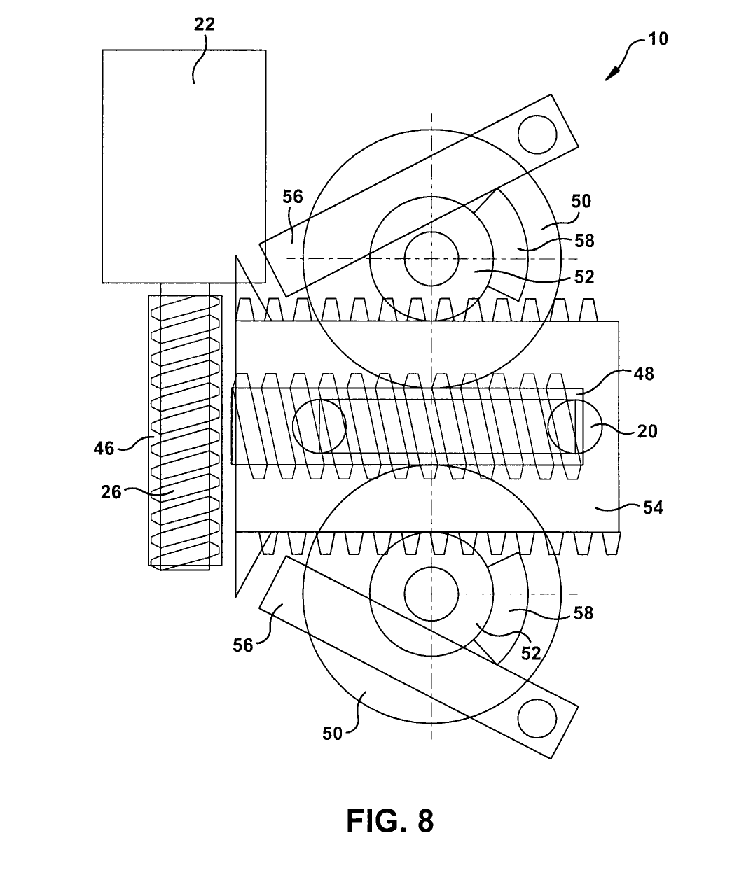

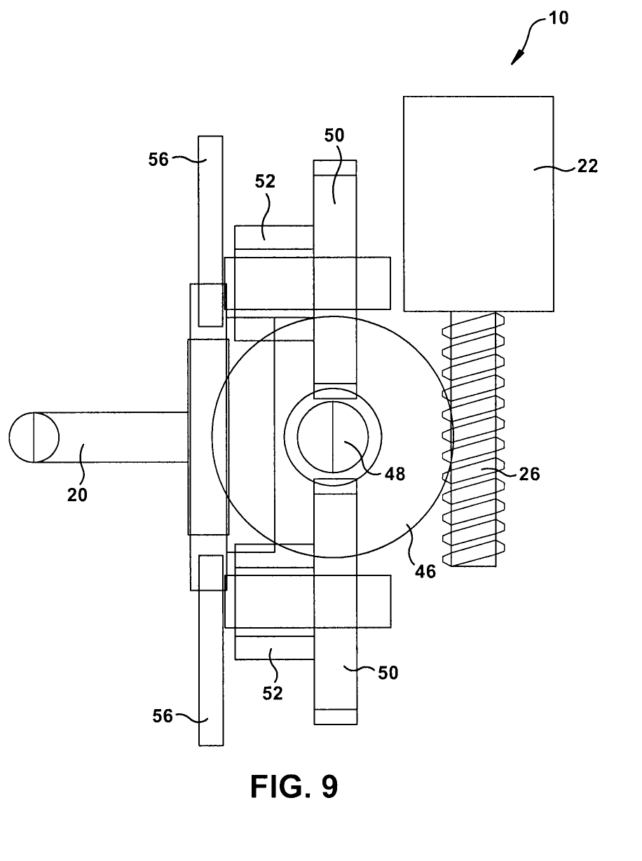

In an embodiment, the powered striker mechanism 10 may drive the striker 20 by way of a series of worm gears connected to a rack and pinion system (FIGS. 8 and 9). The threaded shaft 26 of the motor 22 may engage a first worm gear 46. The first worm gear 46 may drive a second worm 48, which in turn drives a pair of second worm gears 50 (FIGS. 8 and 9). The second pair of worm gears 50 may be arranged perpendicular to and on opposite sides of the second worm 48 (FIGS. 8 and 9). The engagement between the second worm 48 and the second pair of worm gears 50 may create a gear reduction in order to reduce the speed of the gears and increase torque.

The second pair of worm gears 50 may each include a pinion 52 (FIGS. 8 and 9). The pinion 52 may drive a rack 54 (FIGS. 8 and 9). The rack 54 may be configured to move in a direction parallel to the movement between the outer position 12 and the inner position 14. The striker 20 may be connected to the rack 54 such that the rack drives the striker 20 between the outer position 12 and the inner position 14.

The powered striker mechanism 10 may include a pair of lock levers 56 (FIGS. 8 and 9). The lock levers 56 may regulate travel of the rack 54. The lock levers 56 may be movable between an open and closed position. In the closed position, the levers may engage teeth of the rack 54 to prevent the rack 54 from moving. In the open position, the lock levers 56 may be positioned away from the rack 54 to allow the rack 54 to move. The lock levers 56 may be biased toward the closed position by any appropriate type of mechanism, such as a spring or similar type of mechanism (not shown).

A cam 58 may be connected to the pinions 52 and configured to move the lock levers 56 to the open position when the pinions 52 rotate to move the rack 54 and striker 20 to the outer position 14 (FIG. 8). As the pinions 52 move the rack 54 and the striker 20 to the inner position 12, the cams 58 may move to allow the lock levers 56 to buckle or collapse and engage the teeth of the rack 54, thereby preventing further movement of the rack 54.

As an alternative, the powered striker mechanism 10 may include two sets of two part sleeves. The first sleeve may be threaded and may fit inside the other sleeve via a press fit configuration. The amount of press fit drives the amount of force required to move the one part relative to the other part. The outer sleeve may be attached to the striker base plate 38 and may limit the travel of the first part when the maximum travel has been reached.

In use, the powered striker mechanism 10 may absorb energy as it is loaded. The powered striker mechanism 10 may compress the anti-chuck bumper 16 rather than the operator. The bumper 16 may be located in the latch fishmouth 24 or in any other appropriate location. In addition, the striker mechanism 10 may include block outs that may support crash loads whereby the gear train does not have to hold the loads.

Alternatively, the powered striker mechanism 10 may also include energy absorbing mounting bolt features (not shown) that may hold the powered striker's 10 position until a certain load is reached. The bolts may mount into threaded stubs inserted into the sleeves that may require a certain amount of force to move them. This force may be more than the driving force of the screws, but less than the breaking force of the striker 20. At this load, the striker 20 may deflect a given distance and absorb energy as it moves. This may reduce the loading on the striker 20 and improve the vehicle's crash worthiness.

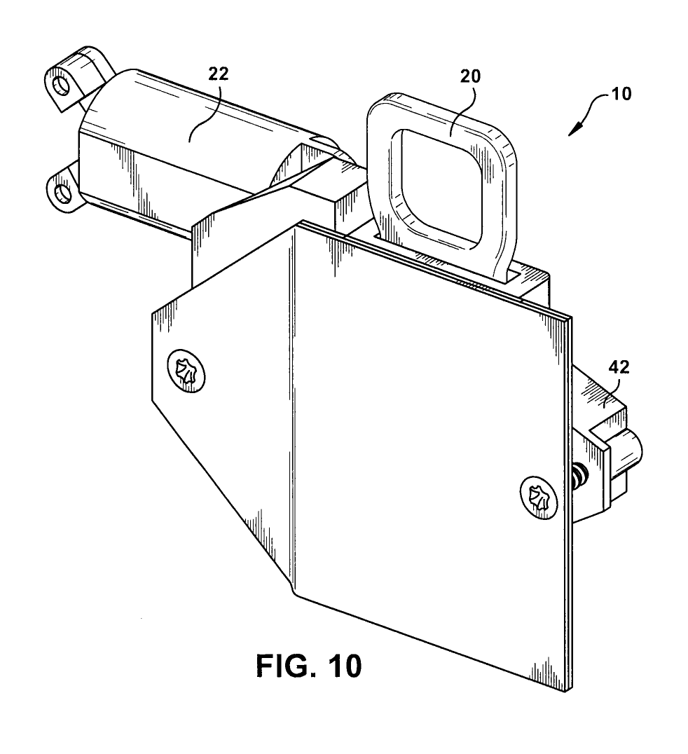

As an alternative, the powered striker mechanism 10 may drive the striker 20 to aid in closing a trunk latch (FIG. 10). The striker 20 may be located and arranged in any appropriate manner to suit any appropriate purpose for the latching situation.

Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of the claims hereafter.

Having thus described the invention, the following is claimed:

1. A powered striker mechanism for mounting to a support structure and for engagement with a latch mechanism to close a door, said powered striker mechanism comprising:
a striker including a front post capable of engagement with the latch;
a drive mechanism secured to a housing, wherein said drive mechanism is engaged with a worm gear to drive a cam;
a taumel gear driven by said cam, wherein said taumel gear includes an output post;
a slide plate located adjacent to said housing; and
a slot located in said slide plate, wherein said post moves said striker linearly along said slot to pull the door closed.

2. The powered striker mechanism of claim 1, wherein said striker is of a post configuration.

3. The powered striker mechanism of claim 1, wherein said striker is of a U-shaped configuration.

4. The powered striker mechanism of claim 1, wherein said drive mechanism is a motor.

5. The powered striker mechanism of claim 1, wherein said striker is moveable between an outer position and an inner position.

6. The powered striker mechanism of claim 5, wherein said striker moves from said outer position towards said inner position thereby moving the latch and the door into a fully closed position.

7. The powered striker mechanism of claim 5, wherein said striker is secured to said slide plate.

8. The powered striker mechanism of claim 7, wherein said slide plate is slidable in a linear direction that is parallel to the movement between said outer position and said inner position.

9. The powered striker mechanism of claim 8, wherein said slide plate moves said striker between said outer position and said inner position.

10. The powered striker mechanism of claim 1, wherein said striker is capable of engagement with a fishmouth of the latch mechanism.

11. The powered striker mechanism of claim 1 further comprising a bumper located on said housing.

12. The powered striker mechanism of claim 11, wherein said bumper is capable of engagement between the latch mechanism and said striker.

13. A powered striker mechanism for mounting to a support structure and for engagement with a latch mechanism to close a door, said powered striker mechanism comprising:
a striker mounted on a housing, wherein said striker includes a front post capable of engagement with a latch;
a motor secured to said housing, wherein said motor is engaged with a series of worm gears; and
a rack and a pinion driven by said series of worm gears.

14. The powered striker mechanism of claim 13, wherein said striker is moveable between an outer position and an inner position.

15. The powered striker mechanism of claim 14, wherein said pinion drives said rack to move in a direction parallel to the movement between said outer position and said inner position.

16. The powered striker mechanism of claim 15, wherein said striker is connected to said rack whereby said rack drives said striker between said outer position and said inner position.

17. The powered striker mechanism of claim 13 further comprising at least one lock lever located adjacent said striker.

18. The powered striker mechanism of claim 13, wherein said striker is of a U-shaped configuration.
